(19) United States
(12) Patent Application Publication
(10) Pub. No.: US 2005/0066315 A1
(43) Pub. Date: Mar. 24, 2005

(54) Localization tool

(76) Inventors: Liem Manh Nguyen, Roseville, CA (US); Terry Robison, Citrus Heights, CA (US); Thomas Vachuska, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/667,476

(22) Filed: Sep. 23, 2003

(51) Int. Cl. G06F 9/45

(52) U.S. Cl. 717/136

(57) ABSTRACT

A code arrangement on a computer-readable medium or media for use in a system for processing localization information may include a transformation module receiving at least one non-localized information unit, the transformation module converting the non-localized information unit into an intermediate format using at least one resource file. A related processor and method may include features similar to the elements of the code arrangement.

### BACKGROUND OF THE INVENTION

Computers can execute software in the same manner unaffected by the geographical location of their operation. For example, even if a computer ‘X’ and a software ‘Y’ running on computer ‘X’ are transported from America to a given location in Asia, the computer ‘X’ will still execute the software ‘Y’ in the same manner irrespective of the geographical location. However, users in the Asian location using the software ‘Y’ are likely to have different requirements due to regional differences, for example, users in the given Asian location would like the software ‘Y’ to communicate messages and perform user interaction using their specific Asian language or dialect. Additionally, the Asian users may want to use different formats for date, time and currency.

Software designed for international users usually offers the necessary regional features based on the region specified by the user. The capability of software to adapt to local/regional requirements is generally known as localization or internationalization. While localization is a desirable characteristic of software, it can be a challenging task for the developer and/or designer of the software to create, maintain and update source code that includes localized code and text spread throughout. Some approaches used to simplify the task of localization are discussed below.

In one conventional approach, an object-oriented class can be used to encapsulate the localization message strings and parameters. For example, the JAVA environment provides a ResourceBundle class that can encapsulate locale-specific objects. ResourceBundles for specific locales can be built in advance, and then queried to generate appropriate text messages depending upon the current locale. A drawback of using ResourceBundle for localization is that all locale-specific text is stored in the code. To effect any change to localization information will involve some recompilation, and hence a longer development cycle.

Another conventional approach involves using property files in addition to the above-described resource encapsulating class. For example, the PropertyResourceBundle class of the JAVA environment is a subclass of the above described ResourceBundle class, and uses a set of static strings stored in files to manage locale-specific information text messages and other data. While property files provide a convenient way to store locale-specific information, the PropertyResourceBundle class cannot capture complex textual messages with localizable parameters.

The PropertyResourceBundle class allows storing of complex text messages in a properties file as separate entries. But the PropertyResourceBundle class lacks the capability to store complex messages as an entry or entries in a database. Further, the property files do not store complex messages as XML strings, and hence limit the variety of uses to which the complex messages can be put.

### SUMMARY OF THE INVENTION

One of the embodiments of the invention is directed to a code arrangement on a computer-readable medium or media for use in a system for processing localization information. Such a code arrangement may include a transformation module receiving at least one non-localized information unit, the transformation module converting the non-localized information unit into an intermediate format using at least one resource file.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 shows an operational block-diagram according to an embodiment of the invention.

FIG. 2A is a flowchart showing the process of creation and storing of XML string according to an embodiment of the present invention.

FIG. 2B is a flowchart showing the process of using the XML string to generate a localized message.

FIG. 3A shows an example of a non-localized message according to an embodiment of the invention.

FIG. 3B shows a resource file for the example of FIG. 2A according to an embodiment of the invention.

FIG. 3C shows a code-snippet for creating an XML string according to an embodiment of the invention.

FIG. 3D shows an XML string for the non-localized message according to an embodiment of the invention.

FIG. 3E shows a code-snippet to access and convert an XML string according to an embodiment of the invention.

FIG. 3F shows a localized message corresponding to an exemplary non-localized message.

FIG. 4 shows a class diagram according to an embodiment of the present invention.

### DETAILED DESCRIPTION OF THE EXEMPLARY EMBODIMENTS

The following description of exemplary embodiment(s) is merely exemplary in nature and is in no way intended to limit the invention, its application, or uses.

An example embodiment of the invention is used to store event messages from a storage area manager (SAM) of a storage area network (SAN) in a database in a localized manner.

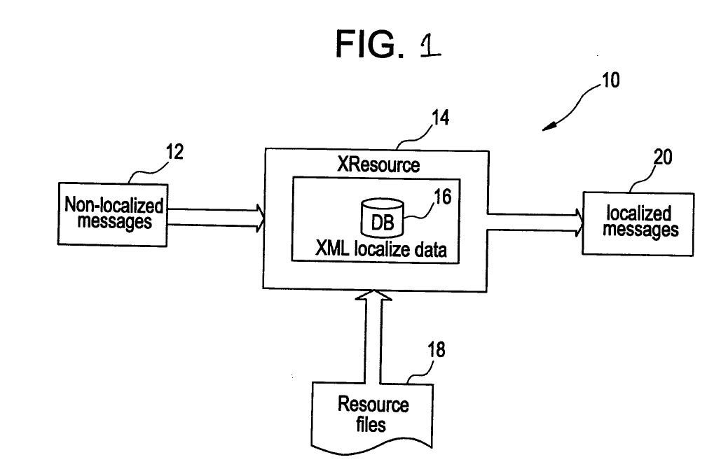

FIG. 1 shows an operational block-diagram according to an embodiment of the invention. The localization processor 10 converts non-localized messages 12 into a stored XML string. Then in a reverse process, the localization processor 10 converts the stored XML string into a localized message 20. Localization processor 10 may employ a transformation module 14 that converts the non-localized messages 12 into XML strings that are stored in a database 16. Transformation module 14 uses resource files 18 in the process of converting non-localized messages 12 into XML strings. Any application can call the transformation module 14 to convert the XML string stored in the database 16 into one of the specific localized messages 20. The detailed operation of the transformation module 14 is described below.

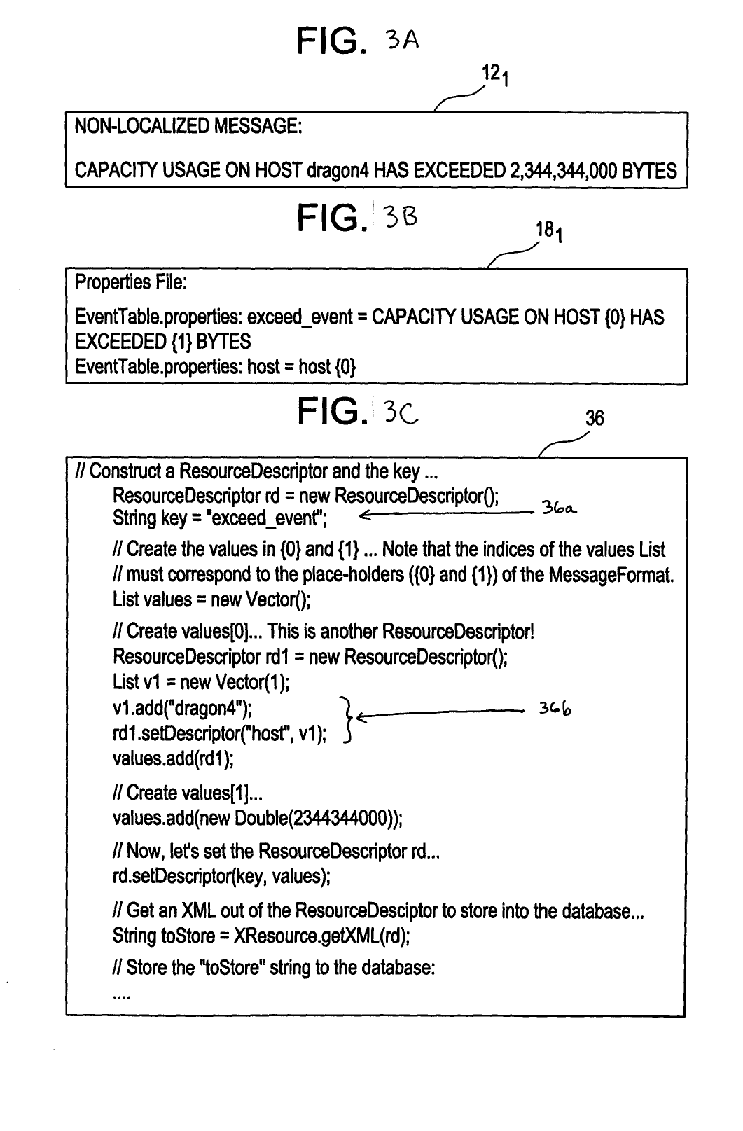

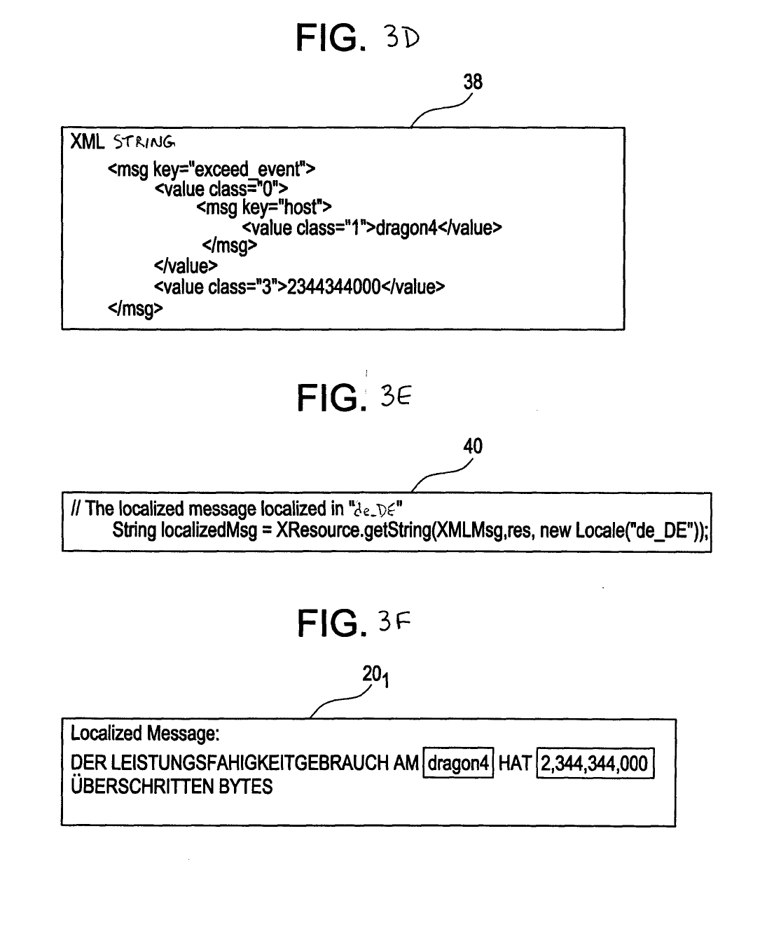

Transformation module 14 can include an XML parser (not shown). According to an embodiment of the invention, the XML parser is a SAX (Simple API for XML) parser. Transformation module 14 receives the non-localized messages 12 as input, such as the non-localized message of FIG. 3A, and then converts them to an intermediate form, e.g., XML strings, before storing the same in the database 16. The database 16 is used only as an illustration of storage that can be used to store XML strings. Those skilled in the art will appreciate that the XML strings can be stored in various types of data-stores. For example, flat files, native XML database, relational databases providing an XML interface or providing string storage facilities may also be used, either singly, or in combination. XML strings, being plain text from a storage point-of-view, can be stored in any storage capable of storing string/text data.

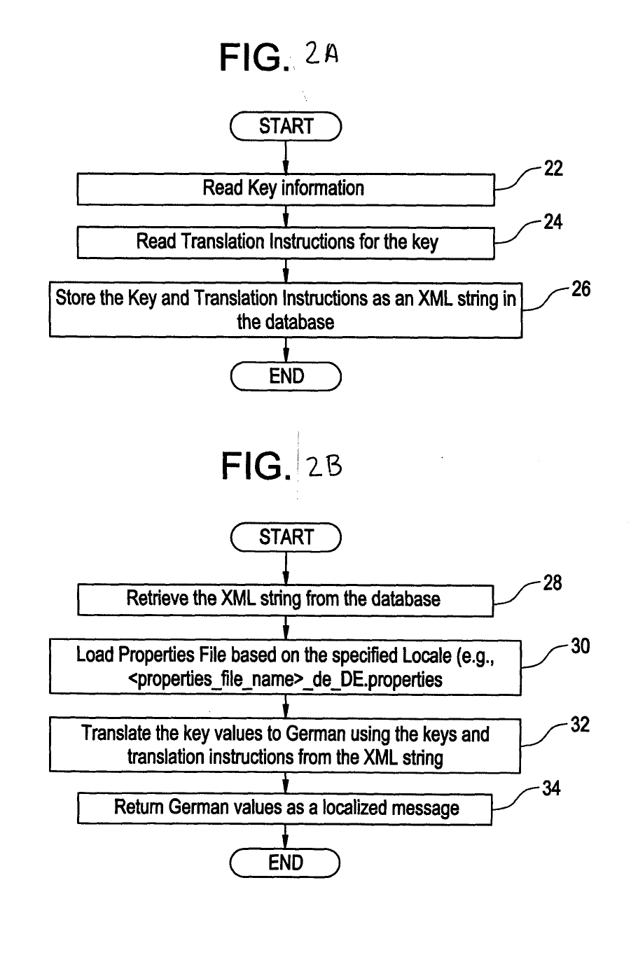

FIG. 2A is a flowchart showing the process of creation and storing of an XML string according to an embodiment of the present invention. The transformation module 14 (shown in FIG. 1) accepts key information as an input at step 22. A key is any information unit that can be localized. Code portion 36a of code snippet 36 illustrated in FIG. 3A is an example of a key. At step 24, the translation instructions associated with the key read above are received as input by the transformation module 14. Code portion 36b of code snippet 36 illustrated in FIG. 3A is an example of translation instructions. At step 26, the key and the translation instructions associated with it are stored in the database 16 (shown in FIG. 1).

FIG. 2B is a flowchart showing the process of using the XML string to generate a localized message according to an embodiment of the invention. After a non-localized message 12 (see FIG. 1 and FIG. 3A) is stored as an XML string in the database 16 (see FIG. 1), the same can be utilized to generate localized messages 20. The stored XML string (38 in FIG. 3D) is retrieved at step 28. A locale-specific resource file 18 (see FIG. 1), i.e. a properties file, is loaded at step 30. The locale is specified by the user or an application. For example, a locale-specific resource file 18 for country Germany and German language can be loaded. Such a locale-specific resource file 18 could be named EventTable_de_DE.properties. The localized message 20 is stored in the German resource file 18. The key values in the non-localized message are translated into German using key and translation information from the XML string. The translated message in German is then returned to the user, the calling application, or any other module as the case may be. A detailed example of applying the above flowcharts according to an embodiment of the invention is described next in the context of FIGS. 3A-3F.

FIG. 3A shows an example of a non-localized message 12; FIG. 3B shows a resource file for the example of FIG. 3A; FIG. 3C shows a code-snippet 36 for creating an XML string 38; FIG. 3D shows an XML string 38 for the non-localized message 12; FIG. 3E shows a code-snippet 40 to access and convert an XML string; and FIG. 3F shows a localized message corresponding to the example non-localized message 12₁. An example of the non-localized message 12 is shown as a non-localized message 12₁. The example is merely an illustration of the non-localized messages 12₁ that can be processed by the localized processor 10. Those skilled in the art will recognize that the non-localized message 12₁ can be of any type and contain any number of parameters. For example, the non-localized message can be an error message with multiple parameters of different data-types like strings, constants, floating-point values, etc.

The resource file 18₁ can include multiple property definitions. Transformation module 14 (shown in FIG. 1) uses the resource file 18₁ to build an XML string 38. According to an embodiment of the invention, the resource files 18 are property files as used in JAVA's PropertyResourceBundle class. While the resource file 18, can be given any file-name, in the present example we assume that the file-name is of the form: <properties_file_name>_de_DE.properties. The “de_DE” in the example indicates that the property file contains details related to the Germany locale and in German language. Those skilled in the art will appreciate that the property file can have any file-name selected by the user, and the above file-name is merely an illustration.

Keys are any information units that can be localized. For example, keys can be text messages, error messages, dates, values, user prompts, etc. The transformation module 14 can persistently store the key information forming part of non-localized messages 12 and the instructions on how to translate this key information into its value(s) counterparts. This is stored in a database entry. To retrieve the text message using transformation module, a locale is specified, for example, “de_DE” in the above illustration. Transformation module 14 will load the correct <properties_file_name>_de_DE.properties file and translate the key information into its German value(s) counterpart and return the German values, which make up the localized message 20. A user of the processor does not have to deal with XML storage and retrieval because the XML processing described above is transparent to the user.

In the present example, an example of properties is shown. The exceed_event property, defined to be a text message “CAPACITY USAGE ON HOST {0} HAS EXCEEDED {1} BYTES.” The curly brackets in the resource file 18₁ operate as place holders for values that are replaced with actual values. At run-time, the actual message based on the exceed_event property of the resource file 18₁ can be expanded to “CAPACITY USAGE ON HOST dragon4 HAS EXCEEDED 2,344,344,000 BYTES”. Thus, the appropriate values for {0} and {1}, i.e., “dragon4” and “2,344,344,000” bytes, can be replaced at runtime. Though the above example has employed a property definition of the type key=value {0} and {1}, those skilled in the art will appreciate that this is merely an example and the same is not limiting in any manner. Any other type of property definition may be used in the resource file 18₁, provided that the transformation module 14 is adapted to recognize the format used therein.

Appropriate software modules can be constructed to store and retrieve non-localized message in the XML format. Convert-to-XML code snippet 36 is an example of code arrangements that can be used to invoke the transformation module 14 to convert the non-localizable message 12₁ into the XML string 38. Those skilled in the art will appreciate that the convert-to-XML code snippet 36 is merely an example and the same is not limiting in any manner.

For example, the object “rd” is a resource descriptor object type used to build the description of the XML-string. In the present example, a string key “exceed_event” is specified first, then a vector with label “values” is used to build an array (vector) of parameter values to be filled in the place-holders ({0} and {1}) of the properties specified in the resource file 18₁. Hence, the values “dragron4” and “2344344000” are added to the values array. Both keys and values may be fed into the resource descriptior rd. Then, the getXML( ) method of the transformation module 14 is called to generate the XML string having XML string 38 corresponding to the key's and values stored in the rd resource descriptor. The getXML( ) method returns the XML string that can be stored in the database 16 (see FIG. 1) or any other logical/physical storage mechanism or media. The database 16 is one example of various types of data-stores that can be used to store XML strings. For example, the data-store can be a flat-file, a XML file, etc. Alternately, an application can dynamically receive and process the generated XML string for other applications.

The stored XML string can be accessed by applications as required. Localization code snippet 40 in FIG. 3D shows an example of code arrangement that can be applied to access the stored XML string in the database 16. The accessing code need only call a single method Xresource.getstring( ) of the transformation module 14. The getstring( ) method is called by passing it the XML message obtained from the stored XML string as described above and the specific locale obtained from a call to Locale( ). In the present example, the locale is considered to be Germany and the language is German. The Xresource.getstring( ) method returns a localized message 20₁ in German language as shown in FIG. 3F.

As discussed above, the localization processor 10 can be used to store non-localized messages 12 into XML representations that can be stored and accessed later. The stored XML strings can be accessed to generate localized messages in any locale-specific language or format. The localized message in the specific language and format includes the parameter based values of variables in the resource property files. In the above example, the parameter values were the host name, “dragon4,” and the {1} free space had the value “2344344000 bytes”.

Complex messages can contain multiple localizable parameters. Thus, using XML strings to store and represent non-localized complex messages with complex multiple parameters provides an easy and convenient way to generate localized messages without the need for recompiling any source-code. Complex messages can include multiple parameters of different types. For example, a complex message can be: “cost=Your cost on volume {0} is {1,number,currency}. The volume is {2,number,percent} utilized as of {3,date,long}”. This complex message includes parameters of multiple types such as number, currency, percentage, date and long. The above example basically says that parameter 0 is just a text string; parameter 1 is a number which should be formatted as a currency value; parameter 2 is a number is formatted as a percentage; and parameter 3 is a date which is long format. The localized version of this message in the English language would be:
Your cost on volume dragon4://c:\ is $234,111.00. The volume is 62% utilized as of Jan. 4, 2003.

Embodiments of the invention can store a non-localized version of such complex message with multiple and differently typed parameters in XML format as a single database entry, and then retrieve and generate localized versions as required. The user or application using an embodiment of the invention will not have to deal with XML strings, since the embodiment provides transparent access to localized versions.

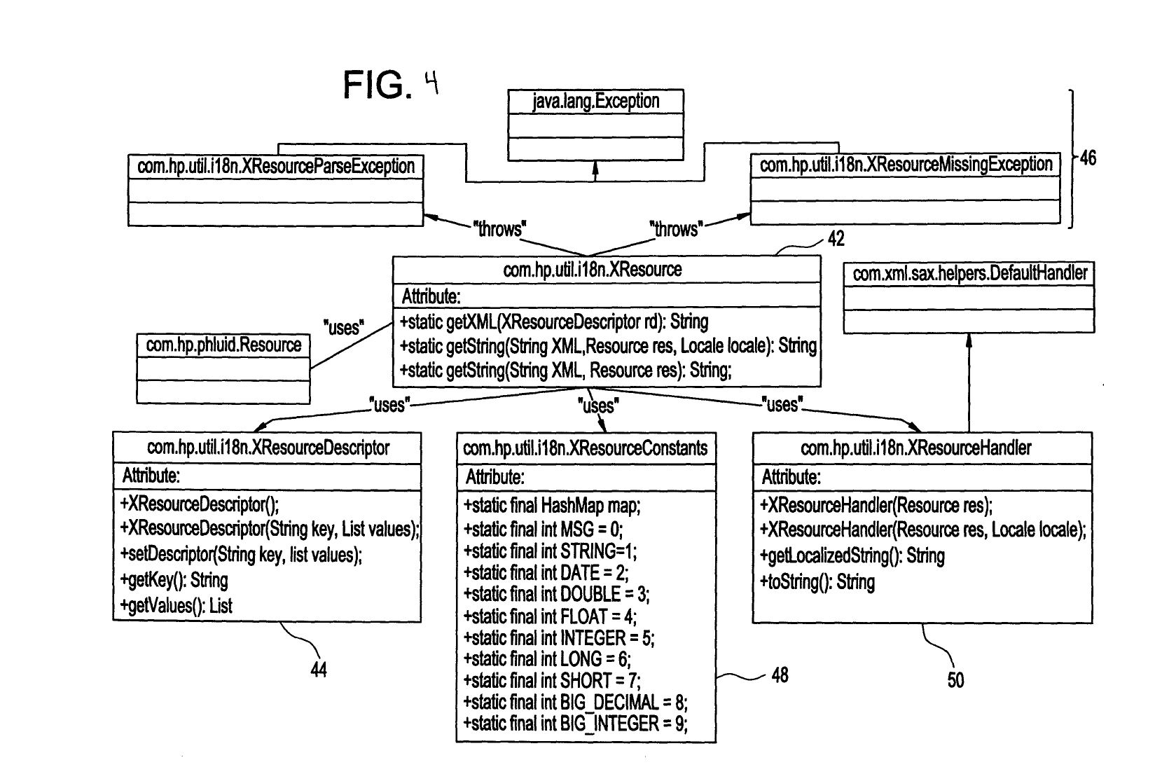

FIG. 4 shows a class diagram according to an embodiment of the present invention. Class 42 is an XResource class representing the transformation module 14 (See FIG. 1). The main methods of class 42 are getXML( ) which is used to convert a non-localized message 12 (see FIG. 1) into an XML string as described above (see FIG. 3C) and getString( ) method which is used to convert the XML string 38 (see FIG. 3D) into a localized message 20 (see FIG. 3F). Resource descriptor class 44 is used to build the resource descriptions as used and shown in FIG. 3C. Other classes supporting the class 42 as shown are exception handling classes 46, constants class 48 and resource handling class 50.

Constants class 48 shows examples of different data-types that can be handled by the transformation module 14. For example, all JAVA types like LONG, INTEGER, DOUBLE, FLOAT, BIGDECIMAL, BIGINTEGER, etc., are covered. Other types, for example MSG, can be also be included in addition to the JAVA types. Those skilled in the art will appreciate that the types listed above are merely illustrations and the same do not limit the invention in any manner.

Those skilled in the art will appreciate that the above class arrangement applies to an embodiment of the invention, and other class arrangements can also be created in other embodiments of the invention.

Although the embodiments of the invention described above utilize an XML string and XML formats, any other string or format (or combination thereof) could also be utilized, as those skilled in the art would appreciate. For example, an embodiment may use a custom-designed SGML DTD (Standardized Markup Language Document Type Definition) to store the key and translation information.

Another embodiment of the invention stores locale-specific information in an updatable manner. Another embodiment of the invention allows the use of property files and the storing of portable and complex messages with multiple localizable parameters.

Another embodiment of the invention permits the re-use of the objects “rd” and “rd1” by reinitializing the objects with the setDescriptor ( ) with a new key and value, after the getXML( ) call.

Embodiments of the invention are disclosed in circumstances where the localization information is language information or data format conversion information. Other types of information could also be used as localization information, as would be known to one of ordinary skill in the art.

It is noted that the functional blocks illustrated in FIG. 1 may be implemented in hardware and/or software. The hardware/software implementations may include a combination of processor(s) and article(s) of manufacture. The article(s) of manufacture may further include machine readable media and executable computer program(s). The executable computer program(s) may include machine readable instructions to perform the described operations. The computer executable program(s) may also be provided as part of externally supplied propagated signal(s) either with or without carrier wave(s).

The description of the invention is merely exemplary in nature and, thus, variations that do not depart from the gist of the invention are intended to be within the scope of the invention. Such variations are not to be regarded as a departure from the spirit and scope of the invention.

1. A localization code arrangement on a computer-readable medium or media for use in a system for processing localization information, the code arrangement comprising:
a transformation module receiving at least one non-localized information unit, said transformation module converting the at least one non-localized information unit into an intermediate format using at least one resource file.

2. The code arrangement of claim 1, said transformation module storing the intermediate format of the at least one non-localized information unit in a data-store.

3. The code arrangement of claim 1, said transformation module using the at least one resource file to generate at least one localized information unit from the at least one non-localized information unit stored within the data-store in the intermediate format.

4. The code arrangement of claim 1, further comprising:
a first module for sending the non-localized information unit to said transformation module, and
a second module for obtaining the localized information unit from said transformation module.

5. The code arrangement of claim 1, wherein the intermediate format of the non-localized information unit is an XML (eXtensible Markup Language) format.

6. The code arrangement of claim 1, wherein the intermediate format of the non-localized information unit is an XML string and the data-store is a database.

7. The code arrangement of claim 1, wherein the resource file is a property file compatible with the JAVA environment.

8. The code arrangement of claim 1, wherein the non-localized information unit includes a plurality of localizable parameters.

9. The code arrangement of claim 8, wherein the intermediate format is an XML format, said transformation module transforming the localizable parameters into the XML format, said transforming module storing the plurality of localizable parameters in the XML format in a data-store.

10. The code arrangement of claim 8, wherein
a plurality of localization instructions are associated with the plurality of localizable parameters, said transformation module transforming the plurality of localization instructions into the XML format and storing the plurality of localization instructions in the data-store.

11. The code arrangement of claim 8, wherein the plurality of localizable parameters are at least one of a string type, an integer type, a floating point value type, a message type, a large integer type, a large decimal type and a date type.

12. The code arrangement of claim 1, wherein said transformation module is implemented as a JAVA class.

13. The code arrangement of claim 1, wherein the localization information is language information.

14. The code arrangement of claim 1, wherein the localization information is data format conversion information.

15. A localization code arrangement on a computer-readable medium or media for use in a system for processing localization information, the code arrangement comprising:
a first module for collecting a plurality of localizable parameters in a first language, said first module further collecting at least one translation instruction for the localizable parameters; and
a transformation module for receiving the plurality of localizable parameters in the first language and the at least one translation instruction from said first module, said transformation module processing the plurality of localizable parameters and the at least one translation instruction into an XML string using a resource file, the resource file including at least one text string in a second language, said transformation module storing the XML string in a data-store.

16. The code arrangement of claim 15, further comprising:
a second module for assembling a plurality of localized parameters in said second language, said second module activating said transformation module to generate said plurality of localized parameters, said transformation module retrieving said stored XML string from said data-store, said transformation module converting said XML string to the plurality of localized parameters in said second language using said resource file and the at least one translation instruction stored in said XML string, said transformation module sending said plurality of localized parameters to said second module.

17. The code arrangement of claim 15, wherein said resource file is configured to handle said second language.

18. A method for processing localization information, the method comprising:
receiving at least one non-localized information unit;
converting said non-localized information unit into an intermediate format using at least one resource file; and
storing said intermediate format in a data-store.

19. The method of claim 18, further comprising:
retrieving said intermediate format from said data-store; and
converting said intermediate format into at least one localized information unit using said resource file.

20. The method of claim 18, wherein said intermediate format is an XML format.

21. The method of claim 18, wherein said data-store is a database.

22. The method of claim 18, said non-localized information unit further including a plurality of localizable parameters.

23. The method of claim 19, the step of converting further including:
converting said localizable parameters into an intermediate format using at least one resource file.

24. The method of claim 21, wherein said localizable parameters correspond to a first language and said localized unit and said resource file correspond to a second language.

25. A method for processing localization information comprising:
collecting a plurality of localizable parameters in a first language;
collecting at least one translation instruction for the localizable parameters;
receiving the plurality of localizable parameters in the first language and the at least one translation instruction;
processing the plurality of localizable parameters and the at least one translation instruction into an XML string using a resource file, the resource file including at least one text string in a second language; and
storing the XML string in a data-store.

26. An apparatus operable to perform the method of claim 18.

27. A computer-readable medium having code portions embodied thereon that, when read by a processor, cause said processor to perform the method of claim 18.

28. An apparatus operable to perform the method of claim 25.

29. A computer-readable medium having code portions embodied thereon that, when read by a processor, cause said processor to perform the method of claim 25.

30. A processor for processing localization information, comprising:
a transformation module receiving at least one non-localized information unit, said transformation module converting the non-localized information unit into an intermediate format using at least one resource file.

31. The processor of claim 30, wherein the localization information is language information.

32. The processor of claim 30, wherein the localization information is data format conversion information.

33. A processor for processing localization information comprising:
a first module for collecting a plurality of localizable parameters in a first language, said first module further collecting at least one translation instruction for the localizable parameters; and
a transformation module for receiving the plurality of localizable parameters in the first language and the at least one translation instruction from said first module, said transformation module processing the plurality of localizable parameters and the at least one translation instruction into an XML string using a resource file, the resource file including at least one text string in a second language, said transformation module storing the XML string in a data-store.
